(19) United States
(12) Patent Application Publication
(10) Pub. No.: US 2015/0208672 A1
(43) Pub. Date: Jul. 30, 2015

(54) POCKET BREAD

(71) Applicant: HITIN BAKERY PRODUCTION DISTRIBUTION OF DOUGH AND BAKED GOODS LTD., Caesarea (IL)

(72) Inventor: Shimshon MATARI, Pardes Hanna-Karkur (IL)

(21) Appl. No.: 14/606,037

(22) Filed: Jan. 27, 2015

(30) Foreign Application Priority Data
Jan. 28, 2014 (IL) 230676

(51) Int. Cl. A21D 13/00; A21D 8/06

(52) U.S. Cl. CPC A21D 13/0067; A21D 8/06

(57) ABSTRACT

Embodiments of the invention relate to pocket bread, comprising: two coplanar bread layers similar in size and dimensions and joined to each other at their respective circumferences, the bread layers defining an internal pocket; wherein each bread layer has a substantially straight edge at one side of its circumference and a substantially arched edge at the opposite side of its circumference. Further embodiments relate to methods of manufacture of the breads, and methods of making sandwiches comprising the breads.

### CROSS-REFERENCE TO RELATED APPLICATIONS

This application claims benefit under 35 U.S.C. §119(a)-(d) of Israeli Patent Application No. 230,676, filed Jan. 28, 2014, the disclosure of which is incorporated by reference herein in its entirety.

### TECHNICAL FIELD

Embodiments of the invention relate to pocket bread and methods of manufacture thereof.

### BACKGROUND

Pita is a type of flatbread, typically based on either whole grain or white wheat flour, common in the Middle East and Mediterranean regions. It has gained popularity in many other regions of the world as well. Pita is typically round or slightly oval shaped, about 1.5-2 centimeters (cm) thick, and comprises two layers which are joined at their perimeters, the layers enclosing a hollow inside. Pita bread is ideal for making sandwiches by opening the pita and exposing the pocket and putting a filling inside. Fillings commonly used to stuff pita include grilled meats, salads, hummus and fried foods such as falafel.

Pita bread is typically made using slightly leavened dough comprising flour, water, salt and occasionally yeast. White flour or whole wheat flour may be used to form the dough. In order to make round or oval pita, a piece of dough is flattened and formed into a round or oval shape. The dough is then introduced into a hot oven usually at a temperature of over 230° Celsius (C). Because of the hot temperature, the outer surface of the dough on its upper and lower surfaces hardens. As the relatively soft dough between the upper and lower surfaces heats up, water vapor is released from the dough, forming a “bubble” of vapor between the two hardened surfaces of the dough. As the dough is heated, the bubble grows, inflating the pita and separating the surfaces from each other, at which point the pita looks “puffed up.” The upper and lower layers of the spherical pita bake while separated from each other and the pita is subsequently removed from the oven. When the pita cools, it deflates to a flat shape with the two layers joined at their perimeters, and defining a hollow pocket between them. Occasionally, the upper and lower layers stick to each other at areas other than the perimeter but are easily separable using a hand or a knife. The outer surface of each layer is typically harder than the corresponding softer, inner surface.

Pita bread, although traditionally handmade, is also mass-produced using automated machinery for dough shaping and baking. Pita bread and methods of its manufacture have been described in U.S. Pat. Nos. 4,889,043; 5,045,329; 5,234,705; 6,063,413; 6,746,701; 7,514,108, United States Application Publication 2007/0292575 and PCT application publication WO 91/03941.

### SUMMARY

Embodiments of the invention relate to a pocket bread which is baked having a sealed perimeter that is substantially semicircular in shape. The semicircular shape improves efficiency of industrial baking processes used in the production of flatbread by reducing waste. The resultant pita pocket also functions better and leads to reduced waste in use than conventional pita pockets. Pocket bread according to embodiments of the invention are easily opened, maintain freshness and are easy to fill with a filling. Such pocket bread may comprise: two coplanar bread layers similar in size and dimensions and joined to each other at their respective circumferences, the bread layers defining an internal pocket, wherein each bread layer has a substantially straight edge at one side of its circumference and a substantially arched edge at the opposite side of its circumference.

Further embodiments of the invention relate to methods for manufacturing pocket bread.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A, 1B, 1C and 1D depict prior art pita bread;

FIGS. 2A and 2B depict pocket breads according to embodiments of the invention, in closed form;

FIG. 2C depicts a pocket bread according to embodiments of the invention, in open form;

FIG. 3 depicts a dough sheet used in a process to make prior art pita;

FIG. 4 depicts a dough sheet used in a process to make pocket bread according to embodiments of the invention.

### DETAILED DESCRIPTION

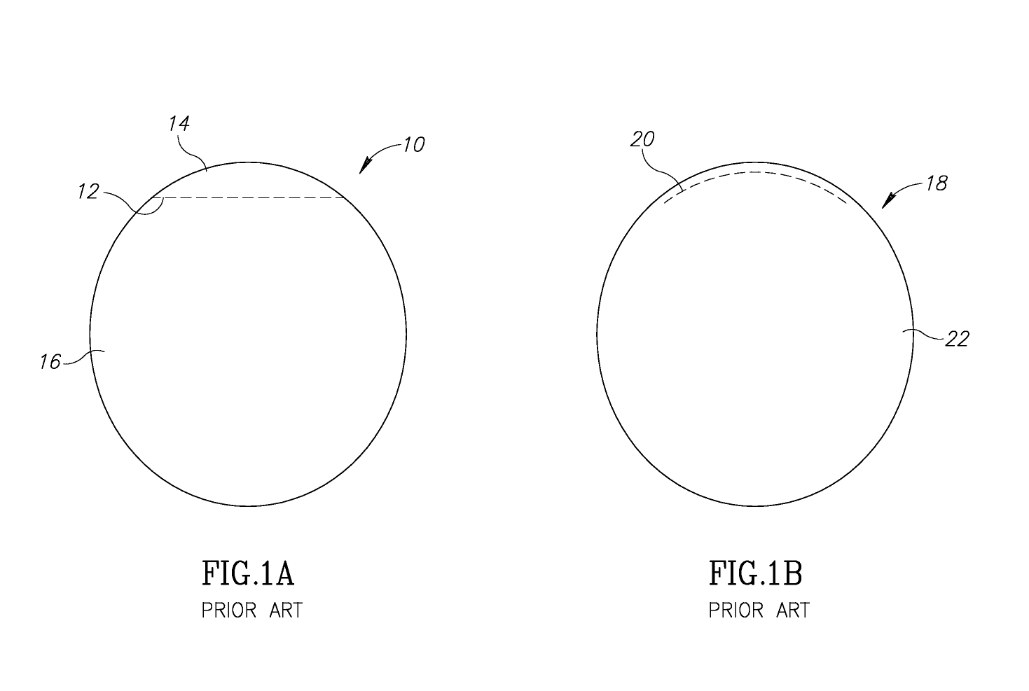

Prior art pita is described in FIGS. 1A-1D. With reference to FIG. 1A, a standard round pita 10 is depicted. In order to prepare a pita sandwich and to fill pita 10 by accessing the internal pocket of pita 10, a cut 12 is made by a sandwich technician. Cut 12 may cut through both layers of pita bread, thereby removing pita end 14 from pita body 16. Pita body 16 may be stuffed with filling and eaten. In such a situation, if the pita sandwich is prepared at a restaurant, pita end 14 is typically discarded. Pita end 14, is generally too small to be filled with filling. Alternatively, a sandwich technician may carefully cut through one layer of pita 10, leaving the other layer intact, and subsequently fill pita body 16 with filling. In this situation, pita end 14 will not have structural integrity to contain filling.

The approach described with reference to FIG. 1A is disadvantageous in that some of the pita is either discarded, or is left-over in a way that it is not easily edible in conjunction with the pita filling. If a sandwich technician enlarges the size of pita end 14 by moving cut 12 towards body 16, he or she will reduce the amount of pita eaten, or reduce the amount of pita eaten with filling. If the technician reduces the size of pita end 14, he or she will reduce the size of the opening to pita body 16, thereby making filling of pita body 16 difficult.

With reference to FIG. 1B, pita 18 is depicted. An alternate approach to accessing the internal pocket of pita 18 is described. A curved slit 20 may be cut through one of the layers of pita 18 parallel to the edge of pita 18, or through the area adjoining both pita layers. Slit 20 may form an opening to provide access to the pocket of pita 18. This approach is also disadvantageous as making a curved slit 20 is difficult and time consuming for sandwich technicians. Cutting curved slit 20 requires careful attention in order to maintain the structural integrity of pita 18. In addition, filling of areas of pita 18, such as area 22, are difficult through the slit, as care must be taken not to widen the slit and decrease the structural integrity of the pita.

With reference to FIG. 1C, pita 24 is depicted. Pita 24 may be split in half through cut 26, thereby forming two halves, half 28 and half 30. Cut 26 is relatively easy to form, and halves 28 and 30 can each be filled without much difficult by a sandwich technician. However, filling two halves of pita by a sandwich technician or eating two halves of pita, as opposed to one full pita, may be more cumbersome. In order to fill entire pita 24 after cut 26 is made, a sandwich technician, after filling half 28 with filling, must carefully place filled half 28 to free his or her hands in order to fill half 30 with filling. In addition, a consumer's eating experience is negatively impacted by eating two halves rather than one full pita, as the consumer can not easily hold both half pita sandwiches in his hands while eating, as he may do while eating a “whole” pita 16 or 18 as depicted in FIGS. 1A-1B.

A sandwich technician may obviate the aforementioned problem of providing a customer with two, cumbersome half pita sandwiches, by using a double portioned, large pita in a round shape, in order to provide half of the large pita to each customer. However, this approach is also problematic in that pita freshness is decreased upon cutting the pita open. If a first customer were to receive a half of a large pita, and the other half pita remained unused for example, for five minutes, until a second customer requested the second half pita, the second customer would receive a second half pita with noticeably decreased freshness, due to the time interval elapsed between the technician's cutting of the pita for the first customer and the serving of the second half pita to the second customer.

With reference to FIG. 1D, a pita 32 is depicted. Pita 32 is rectangular-shaped. Pita 32 may be opened along slit 34, allowing access to the inner pocket. Pita 32 has corners 36 which are difficult to fill with filling. Corners 36 are not easily filled by a sandwich technician. For example, in a case of a sandwich technician filling pita 32 with falafel, due to the confined dimensions of corners 36, falafel balls will not easily fit in the corners, thereby leaving “left over” bread without a significant amount of filling. Such a situation is unacceptable for consumers accustomed to eating their pita bread with a consistent amount of uniformly distributed filling.

Reference is now made to figures which illustrate various aspects of embodiments of the invention.

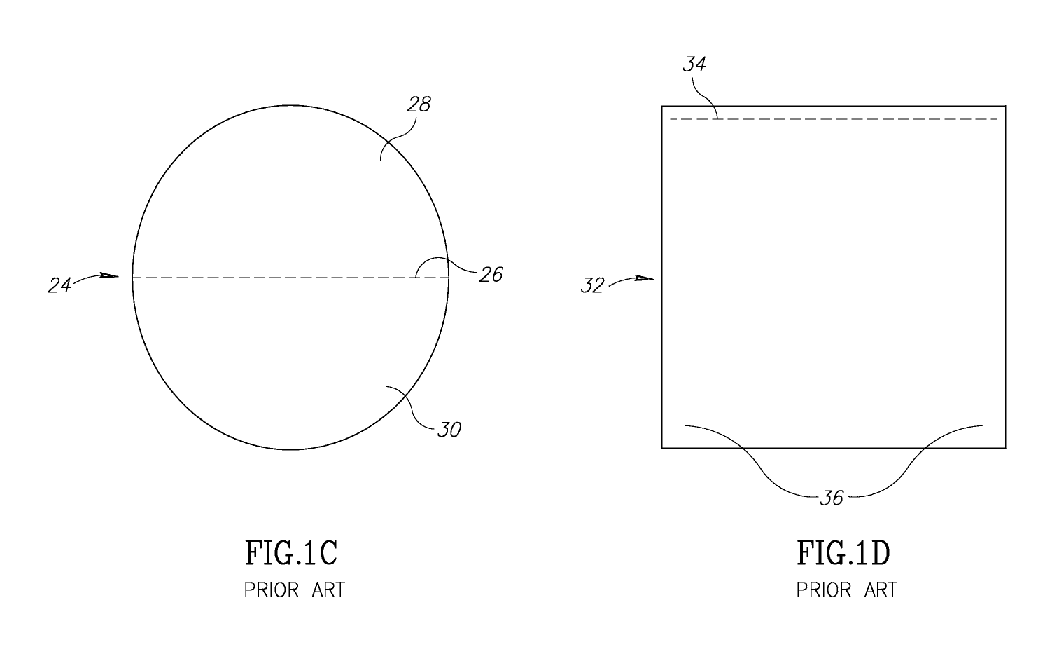

FIG. 2A depicts a pocket bread 50 according to an embodiment of the invention. Pocket bread 50 comprises a straight edge 54, an arched edge 52 and two side edges 56 and 60. FIG. 2A depicts pocket bread 50 after baking and cooling, but before opening and filling with a filling. Pocket bread 50 comprises two coplanar bread layers (only “front” layer is visible in the drawing) similar in size and dimensions and joined to each other at their respective circumferences. The bread layers define an internal pocket, which is accessible by opening the pocket bread along slit 58 at straight edge 54. Arched edge 52 may be semicircular in shape. Side edges 56 and 60 may be slightly curved or straight.

Dimensions of pocket bread according to embodiments of the invention may be between about 100 by 100 mm to about 180 by 180 mm. Preferred embodiments of the invention may be about 140 by 140 to about 150 by 150 mm.

FIG. 2B depicts a pocket bread 70 according to embodiments of the invention. Pocket bread 70 comprises a straight edge 74, an arched edge 72 and two side edges 78 and 80. FIG. 2B depicts pocket bread 70 after baking and cooling, but before opening and filling with a filling. Pocket bread 70 comprises two coplanar bread layers (only “front” layer is visible in the drawing) similar in size and dimensions and joined to each other at their respective circumferences. The bread layers define an internal pocket, which is accessible by opening the pocket bread along slit 76 at straight edge 74. Arched edge 72 is semicircular in shape. Side edges 78 and 80 are curved continuations of arched edge 72.

FIG. 2C depicts a pocket bread 90, similar to pocket bread 50 in FIG. 2A, but in a perspective view, and after being opened, by cutting along the pocket bread's straight edge. Pocket bread 90 comprises an upper bread layer 94, and a lower bread layer 92. Between the bread layers is a pocket 96. Pocket bread 90 comprises a curved edge 98.

Opening of pocket bread 90 (as well as pocket breads 50 and 70) is quick and easy, through a single straight slice along the straight edge. No parts of pocket bread 90 need to be removed and discarded before use, or saved for use by another consumer at a later time. During use of pocket bread 90 after it has been opened, a large, easily accessible pocket 96 may be filled with filling. Because of curved edge 98, no hard-to reach corners are present in pocket bread 90, making the pocket bread easy to fill uniformly, and not leaving areas of bread without an appropriate amount of filling.

Manufacture of pocket bread according to embodiments of the invention may be performed through a variety of methods. Dough may be made by mixing appropriate amounts of water, flour, salt and yeast. Additionally, sugar and/or preservatives may be added. Pieces of dough may be individually formed into a flat shape such as that shown in FIG. 2A or FIG. 2B, having a thickness, preferably, of about 5-7 millimeters (mm) and most preferably 6 mm. The dough may be introduced into a hot oven at a temperature of between 250 and 300° C. The dough may be baked preferably for about 45 to about 70 seconds. During the baking process, because of the hot temperature, the outer surface of the dough on its upper and lower surfaces hardens. As the dough between the upper and lower surfaces heats up, water vapor is released from the dough, forming a large “bubble” of vapor between the two hardened surfaces of the dough. The upper and lower layers of the bubble-shaped pocket bread bake and the pocket bread is subsequently removed from the oven. When the pocket bread cools, it reverts to a flat shape with two layers, joined at their perimeters, defining a hollow pocket inside, having a shape similar to that shown in FIG. 2A or FIG. 2B. The thickness of the pita is preferably between about 18-22 mm.

Alternatively, a sheet of dough may be rolled to appropriate thickness (about 5-7 mm) and stamped by hand with a cookie-cutter type apparatus shaped similar to the pocket bread shown in FIG. 2A or FIG. 2B. Alternatively, a large sheet of dough may be rolled out and a cut by a form having multiple shapes similar to the pocket bread shape. The form may be a cutter formed on a cylindrical press which cuts the dough while rolling over the dough sheet. The leftover dough may be removed and the pocket bread-shaped pieces of dough may be moved into an oven for baking, for example, by a conveyor belt.

Optionally, pocket breads according to embodiments of the invention may be deep-frozen after baking. Deep freezing may enable freshness to be maintained during shipment to retail locations such as supermarkets and bakeries, where pocket breads may be defrosted and sold.

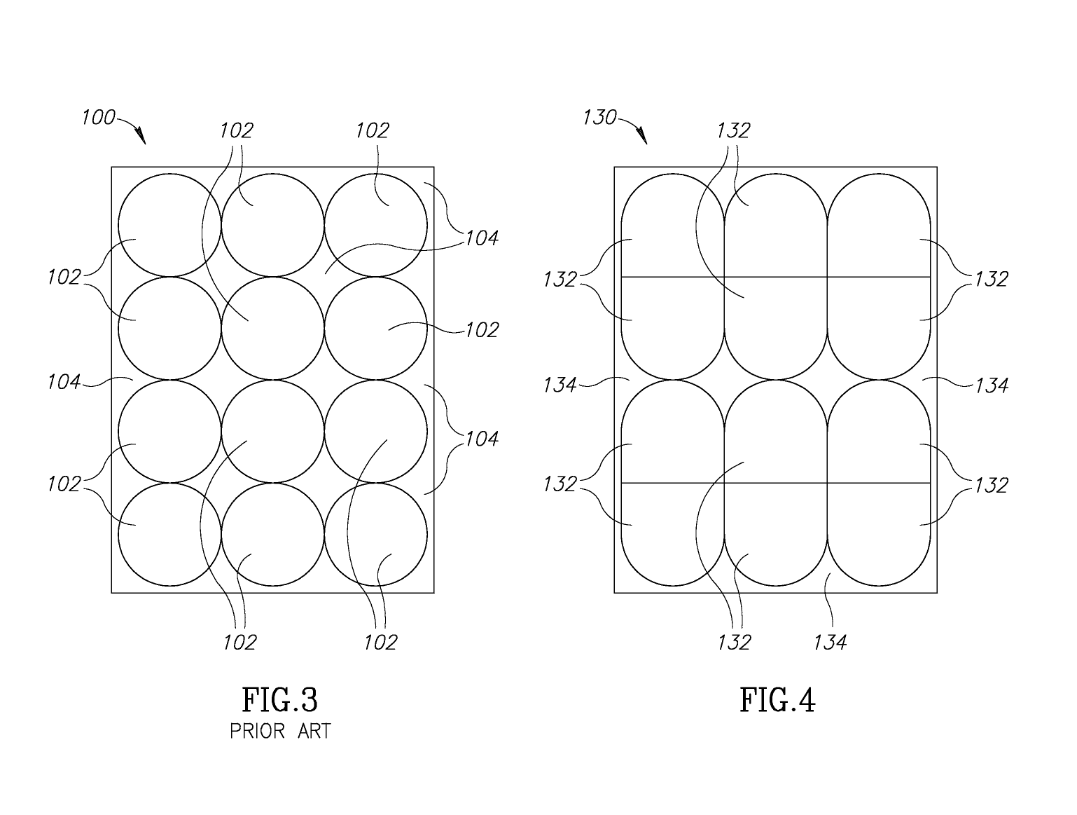

With reference to FIG. 4, dough sheet 130 is portrayed. A form may be prepared comprising many pocket bread shaped apertures, separated by a thin sharp metal cutting device. The form may be lowered onto a horizontal bread sheet and pressed into the bread sheet to form apertures to provide a cut dough sheet as portrayed in FIG. 4. Pocket bread-shaped dough 132 may remain by removing leftover dough 134. Pocket bread-shaped dough 132 may be moved, for example by a conveyor belt, into a hot oven at a temperature of about 250-300° C. for about 45 to about 70 seconds, thereby baking pocket bread-shaped dough 132 to form pocket breads.

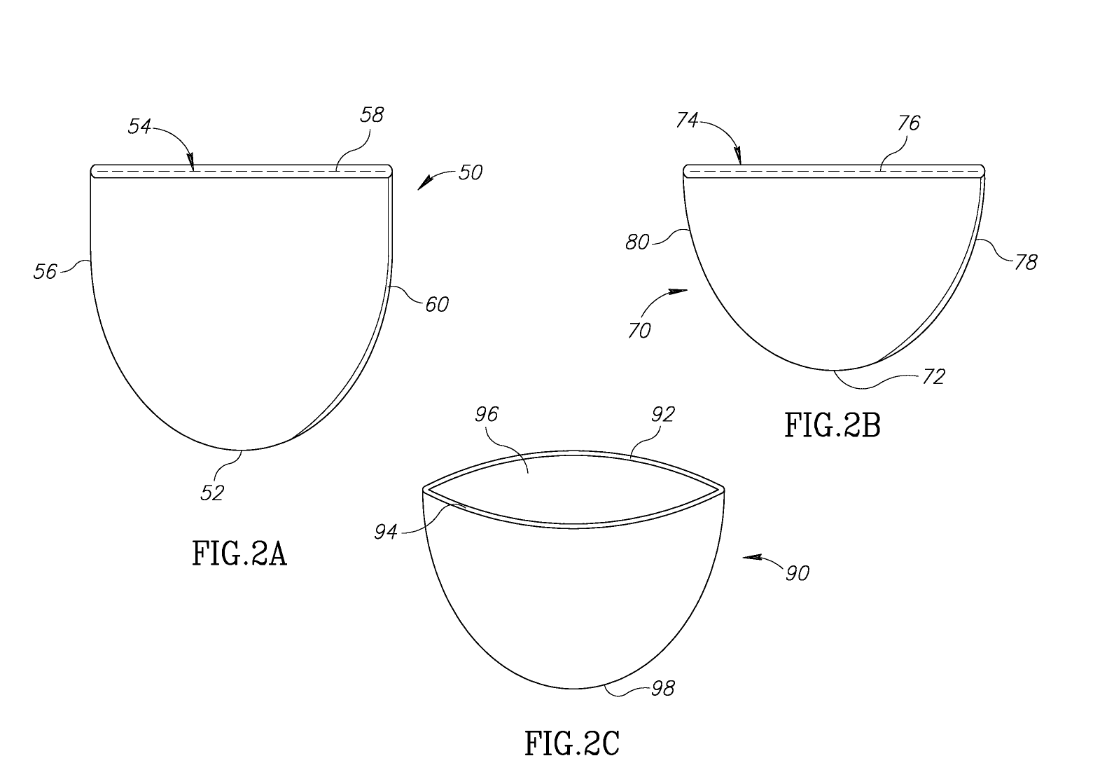

Embodiments of the invention may provide higher yield than prior art process, as evident when comparing FIG. 4 to FIG. 3. FIG. 3 describes prior art processes of making round pita. In FIG. 3, a dough sheet 100 is rolled out to a thickness of about 5-7 mm. A cutter is used to cut out circular pita bread dough 102 and leftover dough 104 is removed. Pita bread dough 102 is then transferred to an oven for baking. The method according to embodiments of the invention as depicted in FIG. 4 has a higher yield than the prior art method depicted in FIG. 3. For a given batch of dough, more bread is baked, and less energy per loaf of bread is utilized by the oven.

For a given sheet of dough having a set thickness, and a size of 45 by 60 cm, 12 round pita bread dough 102 (FIG. 3) loaves for example, having a diameter of 15 cm and a radius of 7.5 cm may be formed. Using a sheet of dough having the same size of 45 by 60 cm, 12 pocket bread-shaped dough 132 loaves may be prepared as depicted in FIG. 4, each pocket bread-shaped dough loaf having a width and length of 15 cm. If the sheet of dough is 6 mm thick, the volume of dough utilized to make bread and the amount discarded is shown in Table 1:

TABLE 1

| Comparison of | Prior Art | Pocket bread |
|---|---|---|
| manufacturing | (FIG. 3) | process (FIG. 4) |
| Dough volume of starting | 1620 cm³ | 1620 cm³ |
| sheet | | |
| Volume of dough used | π*(7.5)²*0.6 = | [0.5*(π*(7.5)²*0.6)] + |
| for each loaf | 106 cm³ | (15*7.5*0.6) = 120.5 cm³ |
| Volume of dough for all | 1272 cm³ | 1446 cm³ |
| (12) loaves in each sheet | | |
| Volume of dough | 328 cm³ | 174 cm³ |
| discarded in each sheet | | |
| Percent dough used | 79% | 89% |
| Percent dough discarded | 21% | 11% |

As shown in Table 1, methods of manufacture of pocket breads according to embodiments of the invention as described in FIG. 4, yield higher yields of bread than prior art methods. Rather than discarding 21% of the dough of a given batch, only 11% is discarded using methods according to embodiments of the invention.

In the description and claims of the present application, each of the verbs, “comprise,” “include” and “have,” and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A pocket bread, comprising:
two coplanar bread layers similar in size and dimensions and joined to each other at their respective circumferences, the bread layers defining an internal pocket;
wherein each bread layer has a substantially straight edge at one side of its circumference and a substantially arched edge at the opposite side of its circumference.

2. The pocket bread according to claim 1 wherein the straight edge and the substantially arched edge opposite the straight edge are joined by two substantially straight or slightly curved edges.

3. The pocket bread according to claim 1 having a thickness of about 1.5 to about 2.5 cm.

4. The pocket bread according to claim 1 having a width and length which are substantially equal.

5. The pocket bread according to claim 1 having a width of between 10 and 18 cm and a length of about 10 and 18 cm.

6. A method for manufacture of a pocket bread according to claim 1, the method comprising:
forming a flattened sheet of dough comprising flour and water;
cutting a shape of dough from the flattened sheet, the shape having a substantially straight edge at one side of its circumference and a substantially arched edge at the opposite side of its circumference; and
baking the dough in an oven.

7. The method according to claim 6 wherein the dough is baked in an oven at a temperature of between 250 and 300° C.

8. The method according to claim 6 wherein the dough is baked for about 45 to about 70 seconds.

9. The method according to claim 6 further comprising allowing the baked pocket bread to cool to room temperature.

10. The method according to claim 6 wherein cutting is performed with a form having multiple apertures, each aperture adapted to cut a pocket bread.

11. The method according to claim 6 wherein the dough further comprises salt and yeast.

12. The method according to claim 6 further comprising deep freezing the pocket bread.

13. The method according to claim 12 further comprising defrosting the pocket bread before use.

14. A method for making a sandwich, the method comprising:
obtaining a pocket bread according to claim 1;
opening the pocket bread along its substantially straight edge; and
filling the pocket bread with a filling.
